(19) United States
(12) Patent Application Publication
(10) Pub. No.: US 2007/0230188 A1
(43) Pub. Date: Oct. 4, 2007

(54) Light-emitting diode light

(76) Inventor: Yi Min Lin, Yingge Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,214

(22) Filed: Mar. 30, 2007

(30) Foreign Application Priority Data
Mar. 30, 2006 (TW) 095205352

(51) Int. Cl. F21V 29/00

(52) U.S. Cl. 362/294; 362/800

(57) ABSTRACT

A light-emitting diode (LED) light includes a ceramic shade, an illuminative unit and at least one wire. The ceramic shade includes a primary chamber defined therein and at least one through hole in communication with the primary chamber. The illuminative unit is disposed in the primary chamber and includes an LED die and a path. The path transfers heat generated by the LED die to the ceramic shade. The wire is connected to the illuminative unit and inserted through the through hole.

### BACKGROUND OF INVENTION

1. Field of Invention

The present invention relates to a light-emitting diode (“LED”) light and, more particularly, to a ceramic shade for an LED light.

2. Related Prior Art

Ceramic radiators have been disclosed in Taiwanese Patent Publication No. 555723 and Taiwanese Patent 1264990 for example. A ceramic shade for a halogen light has been disclosed in Taiwanese Patent M 272223 for example. However, there has never been any ceramic shade for an LED light. Most of the shades for LED lights are made by extrusion of aluminum. An aluminum shade is good at absorbing heat from an LED in operation. However, it is not equally good at dissipating the heat. After reaching thermal saturation, the aluminum shade becomes poor at dissipating heat, thus accumulating heat therein. The accumulation of heat in the aluminum shade causes the temperature of the LED to rise. Unfortunately, the luminance of the LED drops tremendously after the temperature rises above a certain point. Therefore, aluminum shades are not good enough for LED lights.

The present invention is therefore intended to obviate or at least alleviate the problems encountered in prior art.

### SUMMARY OF INVENTION

The primary objective of the present invention is to provide an LED light with a ceramic shade that is excellent in radiating heat.

According to the present invention, a light-emitting diode (LED) light includes a ceramic shade, an illuminative unit and at last one wire. The ceramic shade includes a primary chamber defined therein and at least one through hole in communication with the primary chamber. The illuminative unit is disposed in the primary chamber and includes an LED die and a path. The path transfers heat generated by the LED die to the ceramic shade. The wire is connected to the illuminative unit and inserted through the through hole.

Other objectives, advantages and features of the present invention will 11 become apparent from the following description referring to the attached drawings.

### BRIEF DESCRIPTION OF DRAWINGS

The present invention will be described via detailed illustration of four embodiments referring to the drawings.

FIG. 1 is a perspective view of an LED light according to a first embodiment of the present invention.

FIG. 2 is a cut-away view of a ceramic shade used in the LED light shown in FIG. 1.

FIG. 3 is a cross-sectional view of the LED light.

FIG. 3 A is a cross-sectional view of the LED light, showing a ceramic sheet being in contact with a metal core layer.

FIG. 3B is a cross-sectional view of the LED light, showing a thermal conductive paste being interposed between the primary chamber and a metal core printed circuit board.

FIG. 4 is an exploded view of the LED light showing a reflector fitting in the ceramic shade.

FIG. 5 is an exploded view of an LED light according to a second embodiment of the present invention.

FIG. 6 is an exploded view of an LED light according to a third embodiment of the present invention.

FIG. 7 is an exploded view of a ceramic shade according to a fourth embodiment of the present invention.

### DETAILED DESCRIPTION OF EMBODIMENTS

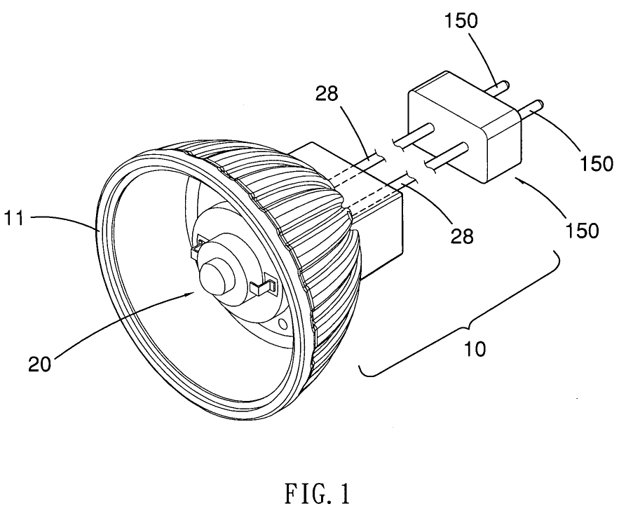

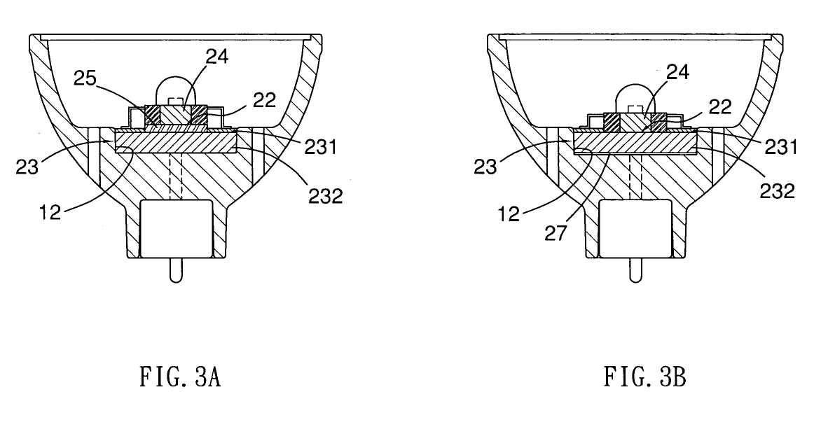

Referring to FIGS. 1 through 3, according to a first embodiment of the present invention, an LED light 10 includes a ceramic shade 11, an illuminative unit 20, wires 28, a connector 15 and two plugs 150. In FIG. 4, the LED light 10 of the present invention further includes a reflector 17.

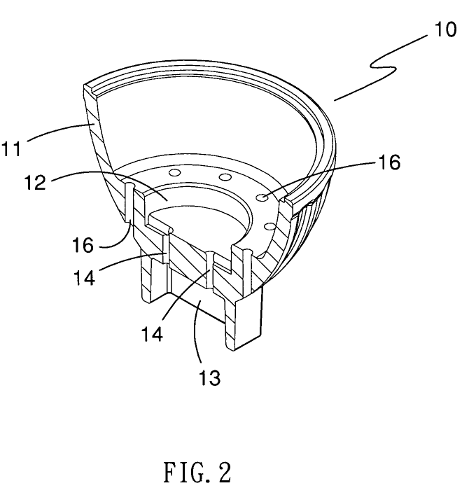

As shown in FIG. 2, the ceramic shade 11 is in the form of a bowl, and includes a primary chamber 12 defined therein, a secondary chamber 13 defined therein, two through holes 14 for communicating the primary chamber 12 with the secondary chamber 13 and a plurality of vents 16 for communicating an interior with an exterior of the ceramic shade 11 so as to enhance a heat dissipation efficiency of the ceramic shade 11.

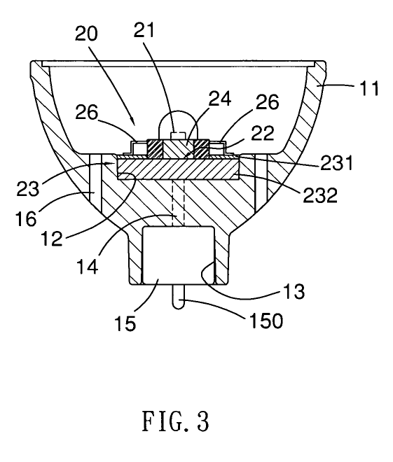

In FIG. 3, the illuminative unit 20 is disposed in the primary chamber 12 and includes at least one LED die 21 and a path 22. The path 22 transfers heat generated by the LED die 21 to the ceramic shade 11. Furthermore, as shown in FIG. 1 and FIG. 3, the wires 28 are connected to the illuminative unit 20 and inserted through the through holes 14 respectively so as to provide utility power to the illuminative unit 20.

In present invention, the ceramic shade 11 has porous characteristics, and the path 22 transfers the heat; therefore, the heat generated by the LED die 21 can be rapidly transferred to the ceramic shade 11. Then, the heat is dissipated by the ceramic shade 11. Therefore, compared with the conventional aluminum shade, the ceramic shade of the present invention provides a better heat dissipation efficiency due to the porous characteristics.

A metal core printed circuit board (“PCB”) 23 is disposed in the primary chamber 12 to carry the LED die 21 and a thermal conductive metal block 24. Two wires 28 are provided on an opposite side of the metal core PCB 23. The metal core PCB 23 includes a metal core layer 232 and a circuit layer 231 formed on the metal core layer 232. The thermal conductive metal block 24 comprises a side is in contract with to the LED die 21, which is electrically connected to two leads 26, and another side in contact with the metal core layer 232. The leads 26 are in turn connected, by soldering for example, to pads formed on the circuit layer 231. Additionally, an isolating layer (not shown) is interposed between the metal core layer 232 and the circuit layer 231.

Accordingly, the path 22 substantially consists of the thermal metal block 24 and the metal core layer 232. Thus, heat can be transferred to the ceramic shade 11 from the LED die 21 through the path 22. The thermal conductive metal block 24 and the metal core layer 232 are preferably made of aluminum.

In FIG. 3A, the path 22 may include a ceramic sheet 25 including a top in contact with the thermal conductive metal block 24 and a bottom in contact with the metal core layer 232.

To avoid poor contact between the metal core layer 232 and the floor of the primary chamber 12 of the ceramic shade 11, the path 22 may include a thermal conductive paste 27 interposed between the metal core layer 232 and the floor of the first chamber 12 of the ceramic shade 11, as shown in FIG. 3B. The thermal conductive paste 27 can be replaced with a thermal conductive tape.

Additionally, as shown in FIG. 1 and FIG. 3, the wires 28 are connected to the circuit layer 231, and the connector 15 is disposed in the second chamber 13 and connected to the wire 28. The plugs 150 are to be plugged in a socket element (not shown).

FIG. 4 shows, the reflector 17 is disposed and fitted in the ceramic shade 11 to reflect light generated by the illuminative unit 20.

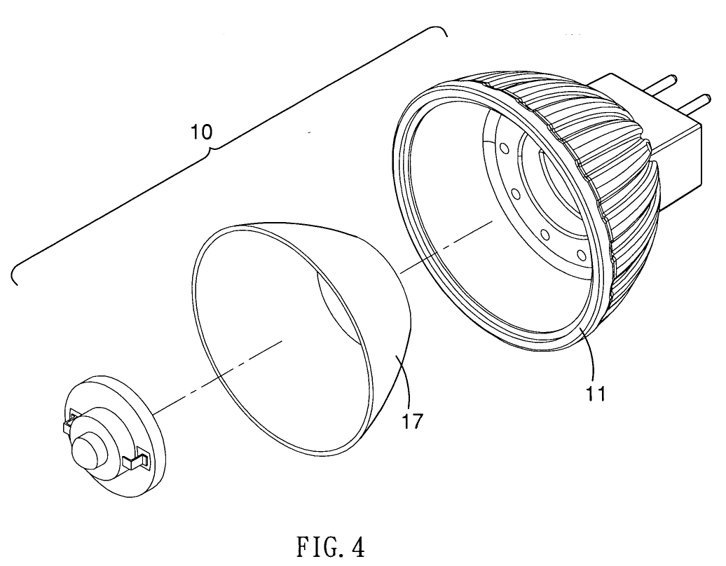

Referring to FIG. 5, shown is an LED light 10a according to a second embodiment of the present invention. The LED light 10a includes an illuminative unit 20, a ceramic shade 11a and a connector 15a which includes two plugs 150a. The ceramic shade 11a is like the ceramic shade 11 except omitting the secondary chamber 13. The connector 15a is like the connector 15 except including a disc-shaped portion for receiving a portion of the ceramic shade 11a. In other words, the connector 15a is connected to the ceramic shade 11a and opposite to the primary chamber 12. Additionally, the ceramic shade 11a of the second embodiment also includes a plurality of vents 16 which is circularly arranged in the primary chamber 12 for venting the heat of the ceramic shade 11a to enhance the heat dissipating efficiency of the ceramic shade 11a.

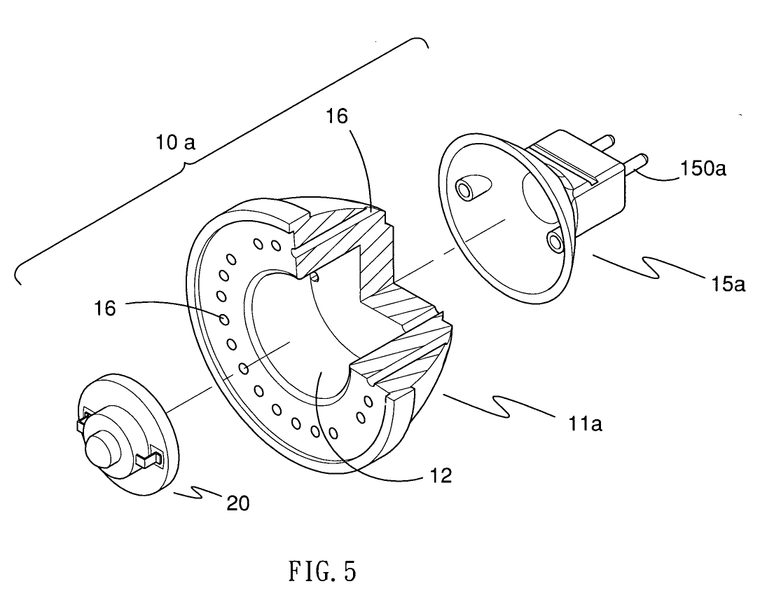

Referring to FIG. 6, shown is an LED light 10b according to a third embodiment of the present invention. The LED light 10b is in the form of a light bulb. The LED light 10b includes an illuminative unit (not shown), a ceramic shade 11b and a connector 15b. The ceramic shade 11b includes a primary chamber 12b for receiving the illuminative unit. The connector 15b is attached to the ceramic shade 11b. The connector 15b includes an electrically conductive tube 150b and an electrically conductive contact point 151b connected to the wires of the illuminative unit (not shown), respectively. The electrically conductive tube 150b is formed with a thread 152. The thread 152 can be engaged with a thread of an electrically conductive sleeve of a socket element (not shown).

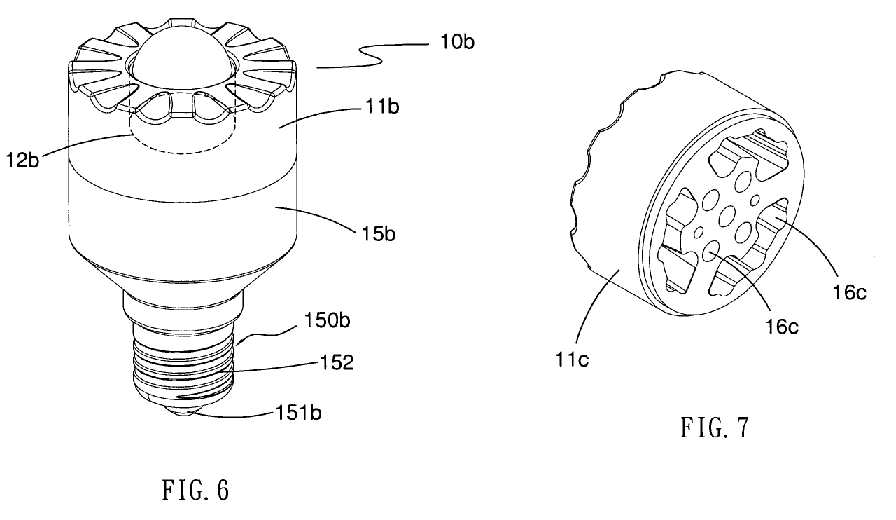

Referring to FIG. 7, shown is a ceramic shade 11c for an LED light according to a fourth embodiment of the present invention. The ceramic shade 11c includes vents 16c of various sizes and shapes. The vents 16c can reduce the weight of the ceramic shade 11c and improve the heat transfer.

The ceramic material of the ceramic shade may include SiC, Al₂O₃ and SiO₂. The ceramic material is porous, and the porosity thereof is preferably 20% to 30%. The Mohs' hardness of the ceramic material is preferably 4 to 7. The bulk density of the ceramic material is preferably 1 to 3 g/cm³. The thermal conductivity of the ceramic material is preferably 4 to 8 w/m-k.

The ceramic shade is made in a process including steps as follows:

Firstly, ceramic powder and paraffin are mixed into fluid ceramic paste.

Secondly, the ceramic paste is injected into the cavity of a mold so that a semi-product of the ceramic shade is made in compliance with the cavity of the mold.

Thirdly, the semi-product of the ceramic shade is sintered into a final product of the ceramic shade.

The ceramic powder preferably includes SiC, Al₂O₃ and SiO₂ mixed at a certain ratio. The ceramic powder preferably includes 60% to 90% of SiC, 5% to 15% of Al₂O₃, 2% to 6% of SiO₂ and 3% to 9% of the paraffin.

The ceramic powder may however include additional ingredients. The paraffin may be replaced with organic materials such as PP or PE.

What is special in this process is the use of the paraffin or similar organic materials to bind the ceramic powder, thus making the fluid ceramic paste. The ceramic paste can flow like molten plastic. Therefore, the ceramic paste can be subjected to the injection step for making the semi-product. The paraffin is vaporized and dissipated during the sintering step. The quality of the final product will not be affected by the paraffin.

The above-mentioned process may be used to make other ceramic objects such as ceramic radiators.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A light-emitting diode (LED) light comprising:
a ceramic shade comprising a primary chamber defined therein and at least one through hole in communication with the primary chamber;
an illuminative unit being disposed in the primary chamber, and comprising at least one LED die and a path for transferring heat generated by the LED die to the ceramic shade; and
at least one wire connected to the illuminative unit and inserted through the through hole.

2. The LED light according to claim 1 wherein the path comprises:
a metal core printed circuit board comprising a metal core layer in contact with a floor of the primary chamber; and
a thermal conductive metal block comprising a side in contact with the LED die and another side in contact with the metal core layer.

3. The LED light according to claim 1 wherein the path comprises:
a metal core printed circuit board comprising a metal core layer in contact with a floor of the primary chamber;
a ceramic sheet being in contact with the metal core layer; and
a thermal conductive metal block comprising a side in contact with the LED die and another side in contact with the ceramic sheet.

4. The LED light according to claim 2 wherein the path further comprises a thermal conductive paste interposed between the floor of the primary chamber and the metal core layer.

5. The LED light according to claim 3 wherein the path further comprises a thermal conductive paste interposed between the floor of the primary chamber and the metal core layer.

6. The LED light according to claim 1 wherein the ceramic shade comprises a secondary chamber for receiving a connector, and wherein the secondary chamber is opposite to the primary chamber, which is in communication with the secondary chamber via the through hole, and the connector comprises two plugs connected with the wire.

7. The LED light according to claim 6 comprising a reflector fitted in the ceramic shade.

8. The LED light according to claim 7 wherein the ceramic shade comprises a plurality of vents in communication with an interior and an exterior of the ceramic shade.

9. The LED light according to claim 2 comprising a connector connected to the ceramic shade and opposite to the primary chamber, wherein the connector comprises two plugs connected to the wire.

10. The LED light according to claim 9 wherein the ceramic shade comprises a plurality of vents circularly arranged in the primary chamber for venting the heat of the ceramic shade.

11. The LED light according to claim 2 comprising a connector with an electrically conductive tube and electrically conductive contact point connected to the wire respectively, wherein the connector is connected to the ceramic shade and opposite to the primary chamber, and the electrically conductive tube is formed with a thread portion.

12. The LED light according to claim 2 wherein a porosity of the ceramic shade is 20% to 30%, the Mohs' hardness of the ceramic shade is 4 to 7, a bulk density of the ceramic shade is 1 to 3 g/cm³, and a thermal conductivity of the ceramic shade is 4 to 8 w/m-k.

13. A ceramic shade comprising a primary chamber defined therein and at least one through hole in communication with the primary chamber, and a porosity of the ceramic shade being 20% to 30%, the Mohs' hardness of the ceramic shade being 4 to 7, a bulk density of the ceramic shade being 1 to 3 g/cm³, and a thermal conductivity of the ceramic shade being 4 to 8 w/m-k.

14. The ceramic shade according to claim 13 comprising a secondary chamber opposite to the primary chamber, which is in communication with the secondary chamber via the through hole.

15. The ceramic shade according to claim 14 comprising a plurality of vents in communication with an interior and an exterior of the ceramic shade.

16. The ceramic shade according to claim 13 comprising a plurality of vents circularly arranged in the primary chamber.

17. A method for making a ceramic shade comprising the steps of:
providing fluid ceramic paste by mixing ceramic powder with paraffin;
making a semi-product of the ceramic shade by injecting the ceramic paste into a cavity of a mold so that the semi-product is made in compliance with the cavity of the mold; and
making a final product of the ceramic shade by sintering the semi-product.

18. The method according to claim 18 wherein the ceramic paste comprises 60% to 90% of SiC, 5% to 15% of Al₂O₃, 2% to 6% of SiO₂, and 3% to 9% of the paraffin.
